(19) United States
(12) Patent Application Publication
(10) Pub. No.: US 2012/0065953 A1
(43) Pub. Date: Mar. 15, 2012

(54) Computer-readable, non-transitory medium storing simulation program, simulation apparatus and simulation method

(75) Inventor: Yutaka Tamiya, Kawasaki (JP)

(73) Assignee: FUJITSU LIMITED, Kawasaki (JP)

(21) Appl. No.: 13/067,612

(22) Filed: Jun. 14, 2011

(30) Foreign Application Priority Data
Sep. 14, 2010 (JP) 2010-205978

(51) Int. Cl. G06G 7/62

(52) U.S. Cl. 703/13

(57) ABSTRACT

A computer-readable, non-transitory medium storing a simulation program that causes a computer to execute a distributed processing by cooperating with a scheduler and another simulation program including: resuming, when a continuation instruction is received from the scheduler, the distributed processing; suspending, when a predetermined time passes after the resuming, the distributed processing; reporting the suspending to the scheduler; generating, when a read or write request of data is received from the other simulation program, a process for processing the read or write request of the data; and processing the read or write request of the data by the process.

### CROSS-REFERENCE TO RELATED APPLICATIONS

This patent application is based upon and claims the benefit of priority of the prior Japanese Patent Application No. 2010-205978 filed on Sep. 14, 2010, the entire contents of which are incorporated herein by reference.

### FIELD

A certain aspect of the embodiments discussed herein is related to a simulation program, a simulation apparatus and a simulation method for carrying out a distributed simulation in distributed surroundings.

### BACKGROUND

If a large scale LSI system is simulated in its entirety, the LSI system may be divided into plural portions and the divided portion are modeled. Said differently, the divided portions are simulated using a simulation program (hereinafter, simply referred to as SP) matching abstraction levels inherent in the models.

There are a circuit level, a RT level and a C level in the abstract levels inherent in the models. In the circuit level, the SP called Simulation Program with Integrated Circuit Emphasis (SPICE) may be used. In the RT level, the SP called Verilog Simulator may be used. In the C level, the SP called SystemC may be used.

Plural SPs carry out synchronization (communication between SPs) of a time or data by mutually communicating and simulation of the whole system. Thus, a distributed simulation environment is established.

For example, Japanese Laid-open Patent Publication No. 05-101015 discloses a simulation apparatus of a concurrent control type.

Further, Japanese Laid-open Patent Publication No. 2004-265054 discloses a semiconductor integrated circuit function simulation device capable of simulating the same parallel processing as the operation of an actual semiconductor integrated circuit.

### SUMMARY

According to an aspect of the embodiment, there is provided a computer-readable, non-transitory medium storing a simulation program that causes a computer to execute a distributed processing by cooperating with a scheduler and another simulation program including: resuming, when a continuation instruction is received from the scheduler, the distributed processing; suspending, when a predetermined time passes after the resuming, the distributed processing; reporting the suspending to the scheduler; generating, when a read or write request of data is received from the other simulation program, a process for processing the read or write request of the data; and processing the read or write request of the data by the process.

The object and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example system structure of a distributed simulation environment;

FIG. 2 illustrates an example distributed simulation based on a Loosely-Timed Model;

FIG. 3 schematically illustrates an example model structure of an SP;

FIG. 4 is an example time chart of processing a CmdWriteData command from the SP11 in a target thread 24 of the SP 12 under the model structure of the SP 12 illustrated in FIG. 3;

FIG. 5 illustrates an example system structure of a distributed simulation environment;

FIG. 6 illustrates an example hardware structure of a computer running the scheduler or the SP;

FIG. 7 is an example time chart illustrating an action of the target thread of an embodiment;

FIG. 8 is an example time chart illustrating an action of an initiator thread of the Embodiment;

FIG. 9 is an example time chart for explaining an effect of the embodiment;

FIG. 10 is a schematic view for explaining an effect of the embodiment.

FIG. 11 illustrates an example structure of a simulation process;

FIG. 12 is an example flowchart of an initiation process;

FIG. 13 is an example flowchart of a target thread process;

FIG. 14 is an example flowchart of processing with a processing thread;

FIG. 15 is an example flowchart of an initiator thread process;

FIG. 16 is an example flowchart of an end process;

FIG. 17 illustrates an example structure of a function of a C level;

FIG. 18 illustrates the example structure of the function of the C level; and

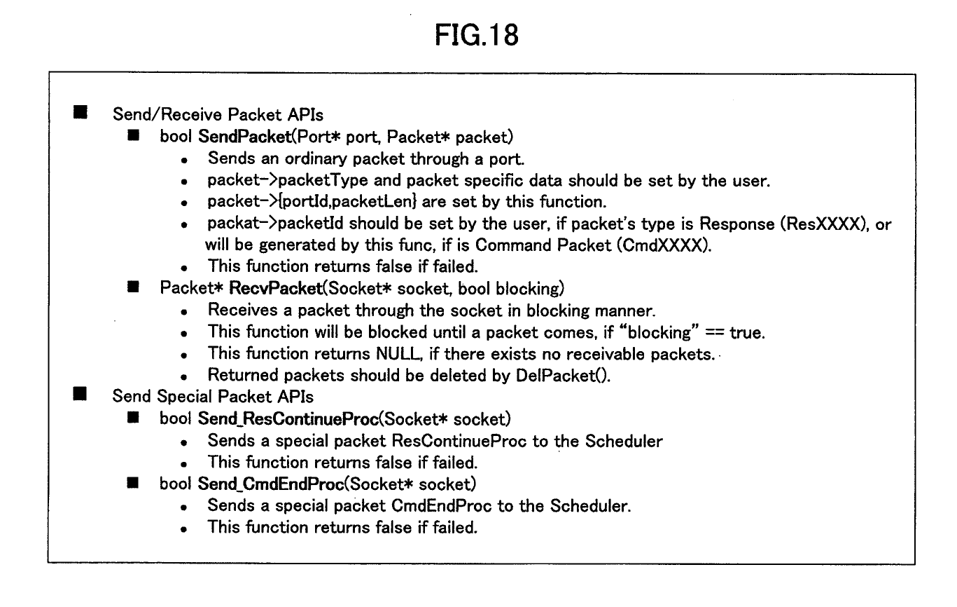

FIG. 19 illustrates the example structure of the function of the C level.

### DESCRIPTION OF EMBODIMENT

There are many types of the SP and many providing vendors of the SP. Therefore, it is possible to early launch the distributed simulation environment with the minimum labor by realizing a system in which SPs mutually communicate. One of speeding-up techniques may be an asynchronous execution between the SPs based on the Loosely-Timed Model.

However, it is difficult to describe a model realizing a deadlock-free communication between the SPs because the SPs are not prepared for a distributed simulation such as SystemVerilog and SystemC. Here, the terminology of “deadlock” means a situation in which plural SPs mutually wait for completions of processing which causes a freeze of the entire processing. On the contrary, the terminology of “deadlock free” means nonoccurrence of “deadlock”. Preferred embodiments of the present invention will be explained with reference to accompanying drawings.

The embodiment provides a model of avoiding the deadlock between SPs which are not prepared for distributed simulation based on the Loosely-Timed Model. Such SPs may be SystemVerilog or SystemC.

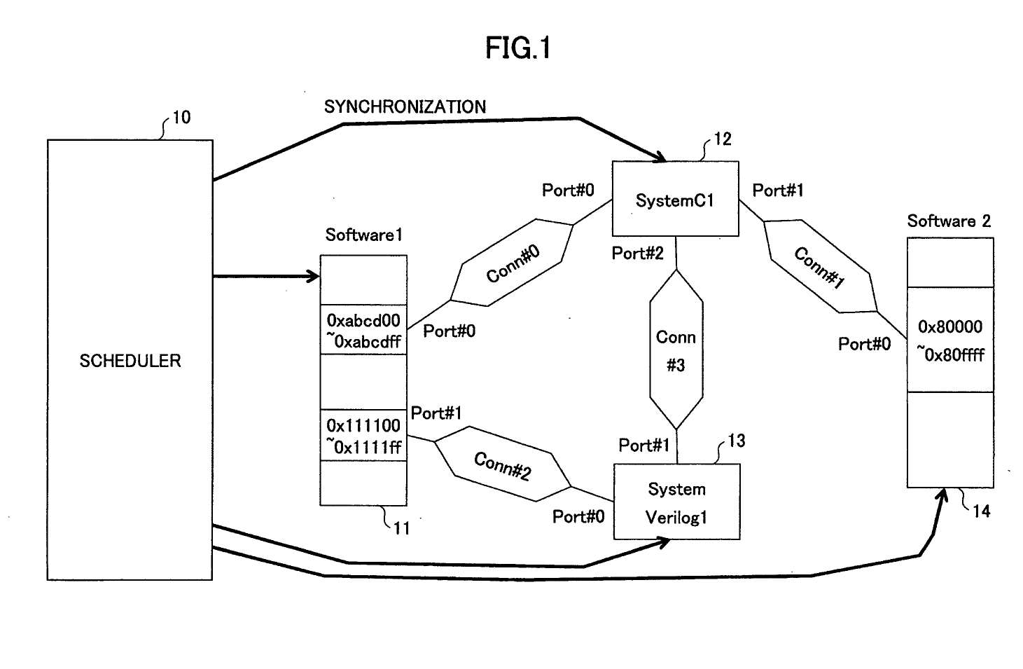

FIG. 1 illustrates an example system structure of the distributed simulation environment. The distributed simulation environment illustrated in FIG. 1 is formed to include a scheduler 10 and plural SPs 11 to 14. Simulation of an entire LSI circuit system is realized by a parallel action of plural SPs 11 to 14.

The scheduler 10 manages a global simulation time. The scheduler 10 synchronizes simulation times of the SPs 11 to 14 by instructing execution and stop (or resuming and suspending) of the simulation using a communication function between SPs.

The SPs 11 to 14 simulates models controlled by the SPs themselves in accordance with an instruction from the scheduler 10. The SPs 11 to 14 give data to and receive data from the other SP using a communication function between SPs called Port in a case where reading or writing of the data is necessary during the simulation with the SPs 11 to 14. For example, the SP 11 and SP 12 illustrated in FIG. 1 can give or receive the data using Port#0.

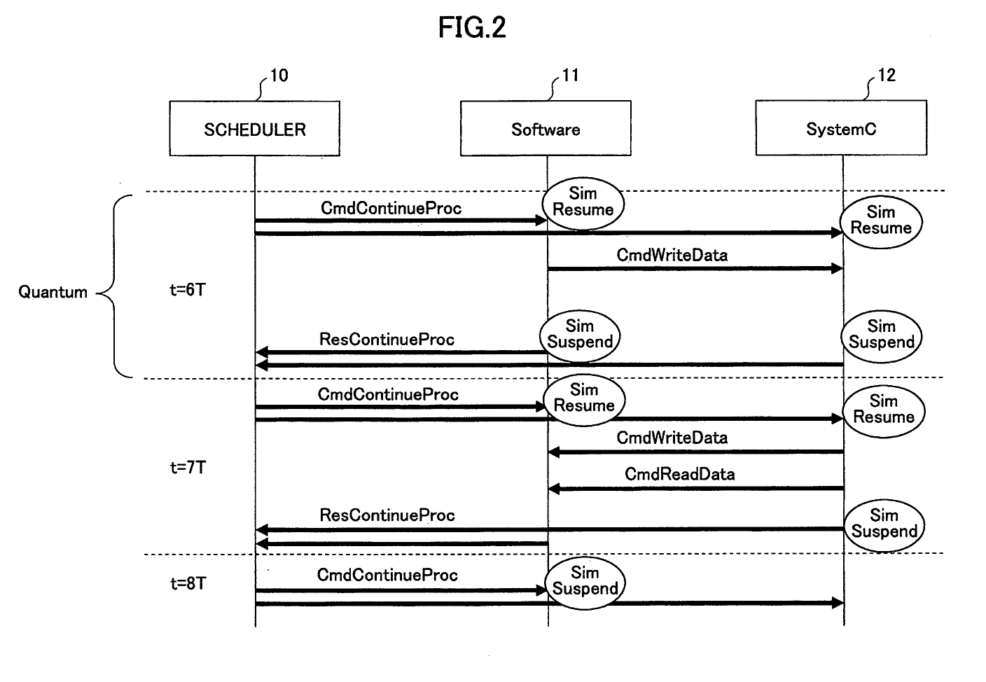

FIG. 2 illustrates an example distributed simulation based on a Loosely-Timed Model. The scheduler 10 gives a time slot value called Quantum to the SP 11 and 12 to thereby enable the SP 11 and SP 12 simulating during a Quantum period. A degree of freedom of the simulation is enhanced because a schedule of event processing during the Quantum period is arbitrarily determined by the SP 11 and SP 12. As a result, the distributed simulation based on the Loosely-Timed Model is sped up.

The action of the scheduler is to give a simulation continuing command (CmdContinueProc) to the SP 11 and the SP 12 at the beginning of the Quantum period. The SP 11 and the SP 12 simulate during the Quantum period in a case where the CmdContinueProc command is received. In a case where the data are given or received during the Quantum period, a CmdWriteData (data writing request) command or a CmdReadData (data reading request) command are issued.

The SP 11 and the SP 12 temporally stops or suspends the simulation at the end of the Quantum period and reports a ResContinueProc (simulation completion) to the scheduler 10. The scheduler 10 confirms returns of the ResContinueProc from all of the SP 11 and the SP 12. After the confirmation, the scheduler 10 sets the global simulation time to be the next Quantum period.

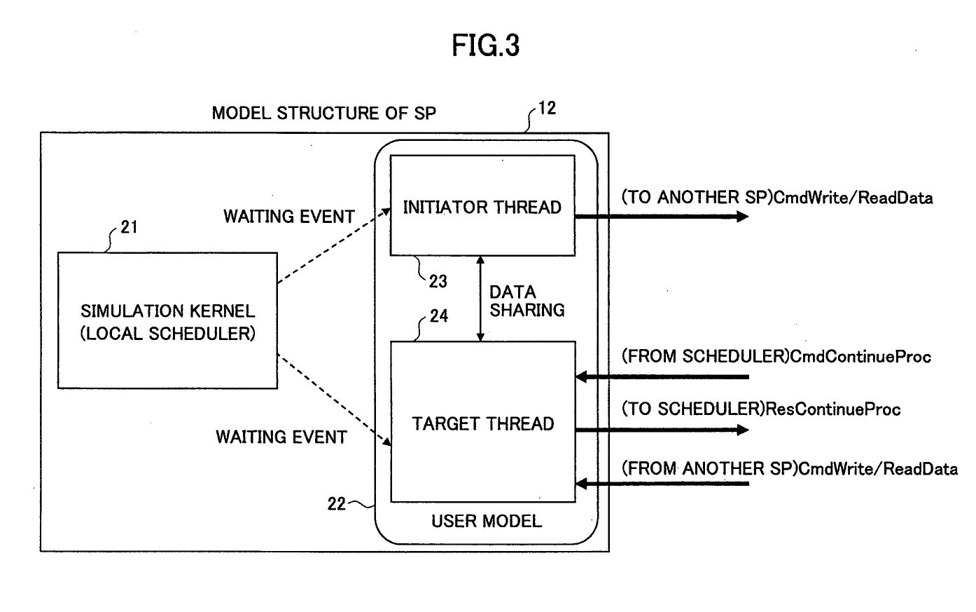

FIG. 3 schematically illustrates an example model structure of an SP.

The SP 12 includes a simulation kernel (local scheduler) 21 and a user model 22. The user model 22 includes an initiator thread 23 and a target thread 24. The SP such as SystemVerilog and SystemC may not be prepared for the distributed simulation.

The SP 12 illustrated in FIG. 3 hardly acquires the simulation kernel 21. Therefore, a communication function between SPs is installed in the initiator thread 23 and the target thread 24 of the user model 22.

The SP 12 such as SystemVerilog and SystemC has a function of calling a host OS function (TCP/IP communication function such as socket ( ), send ( ) and recv ( )) other than the simulation. If the SP 12 of the embodiment calls the host OS function from the initiator thread 23 and the target thread 24, the following actions occur.

The initiator thread 23 issues a command (CmdWriteData, CmdReadData or CmdWriteData and CmdReadData) to another SP. The target thread 24 reports ResContinueProc to the scheduler 10.

The target thread 24 waits for commands (CmdContinueProc, CmdWriteData and CmdReadData) used for the communication between the SPs. An event on the simulation carried out by the SP 12 is waited.

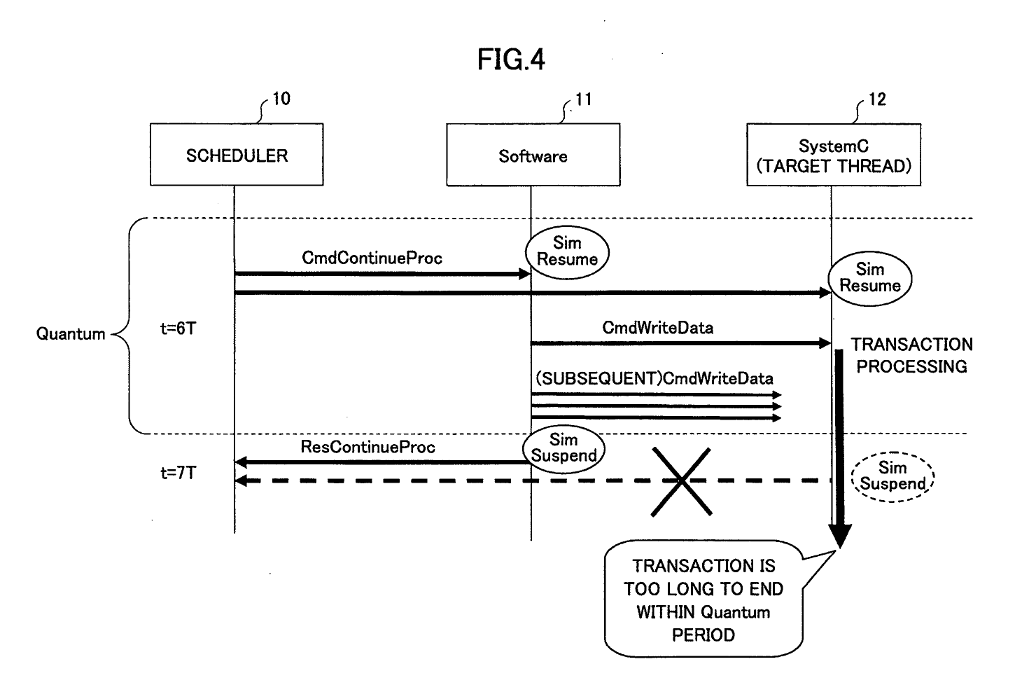

FIG. 4 is an example time chart of processing a CmdWriteData command from the SP11 in the target thread 24 of the SP 12 under the model structure of the SP 12 illustrated in FIG. 3. The SP 12 cannot anticipate a simulation time for a transaction processing.

With FIG. 4, the transaction processing with the SP 12 takes a long time, and the transaction processing does not ends within the given Quantum period. If the simulation time exceeds the given Quantum period, the SP 12 may not be able to return ResContinueProc to the scheduler 10. If ResContinueProc is not returned to the scheduler, the SP 12 resultantly causes the deadlock of the distributed simulation.

In order to stop the operations of the other SP such as the SP 11, the SP 12 receives a subsequent CmdWriteData command during the transaction processing. If the subsequent CmdWriteData command is not received during the transaction processing, the SP 12 causes the deadlock of the distributed simulation. As described, the model description of the target thread 24 of the SP 12 of the distributed simulation may have a difficult problem.

Therefore, the SP 12 of the distributed simulation of the embodiment provides a transaction processing thread (hereinafter, referred to as a processing thread) in which the transaction processing is carried out in addition to the target thread 24. The target thread 24 devotes to a receipt of the communication among the scheduler 10 and the SPs and a control of the Quantum period. A case where a process as an executable unit is a thread is described in the embodiment. However, the process as the executable unit may be a task.

When the target thread receives a CmdWriteData command or a CmdReadData command from another SP. the target thread generates a processing thread and makes the processing thread carry out transaction processing. The target thread 24 prepares for a receipt of the subsequent CmdWriteData command or the subsequent CmdReadData command.

The processing thread is generated by the target thread 24. Thereafter, the transaction processing requested by the target thread 24 is carried out and returned to another SP of a request source. Thereafter, the processing thread is ended by itself.

In a case where the initiator thread 23 issues the CmdWriteData command or the CmdReadData command to another SP, an ID is added to the CmdWriteData command or the CmdReadData command. The initiator thread 23 associates information of the issued CmdWriteData or CmdReadData command with the ID added to the CmdWriteData or CmdReadData command and reports the associated information and ID to the target thread 24. The target thread 24 stores the information of the issued CmdWriteData or CmdReadData command issued by the initiator thread 23 and the ID added to the CmdWriteData or CmdReadData command into a table after associating these.

The'target thread 24 once receives a response of the CmdWriteData or CmdReadData command from another SP. The target thread 24 refers to the table and acquires the information of the CmdWriteData or CmdReadData command corresponding to the ID described in the response.

The target thread 24 reports an issue that the CmdWriteData or CmdReadData command ends to the initiator thread 23 which issues the CmdWriteData or CmdReadData command based on the acquired information. In a case of the response (ResReadData) to the CmdReadData command, the target thread 24 stores data obtained as a result of reading into a designated region.

### (System Structure)

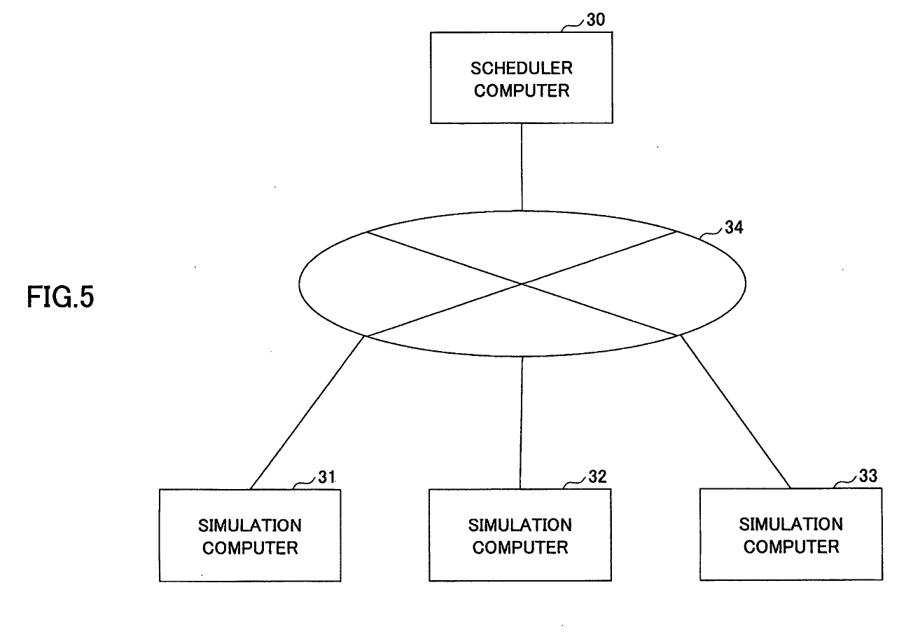

FIG. 5 illustrates an example system structure of the distributed simulation environment. The system illustrated in FIG. 5 is formed by connecting a scheduler computer 30 to plural simulation computers 31 to 33 via a network 34 such as the Internet and a Local Area Network (LAN) so that data are communicable among the scheduler computer 30 to the plural simulation computers 31 to 33.

The scheduler computer 30 runs the scheduler 10. The simulation computers 31 to 33 may run the SP 11 to 14. The system of FIG. 5 includes three simulation computers 31 to 33. However, the number of the simulation computers may be other than three. The system of FIG. 5 may use a virtual platform and the scheduler 10 and the SP 11 to 14 are run on a virtual computer to realize the system of FIG. 5.

### (Hardware Structure)

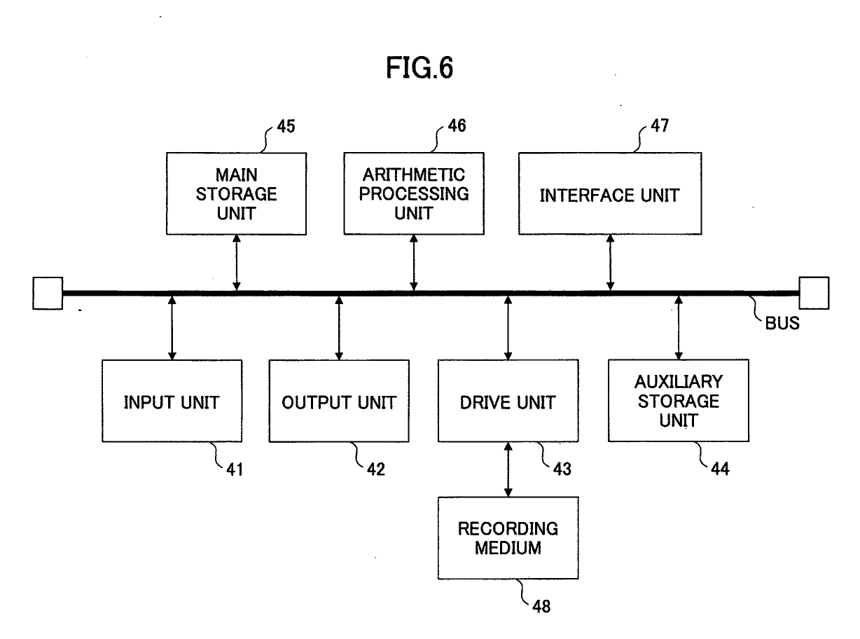

FIG. 6 illustrates an example hardware structure of a computer running the scheduler or the SP. The computer illustrated in FIG. 6 includes an input unit 41, an output unit 42, a drive unit 43, an auxiliary storage unit 44, a main storage unit 45, an arithmetic processing unit 46 and an interface unit 47, mutually connected by a bus B.

The input unit 41 may be a keyboard or a mouse. The input unit 41 is used to input various signals. The output unit 42 may be a display device or the like. The output unit 42 may be used to display various windows, data or the like. The interface unit 47 is a mode, a LAN card or the like. The interface unit 47 is used to be connected to the network 34.

The scheduler 10 of the embodiment is at least a part of the various programs controlling the scheduler computer 30. The schedulers 11 to 14 of the embodiment are at least a part of the various programs controlling the simulation computers 31 to 33. The scheduler 10 and the SP 11 to 14 may be served by a distributed recording medium 48 or downloading via the network 34. The recording medium 48 in which the scheduler 10 or the SP 11 to 14 are recorded may be an optical, electric or magnetic disk such as a CD-ROM, a flexible disk and a magnet-optical disk, a semiconductor memory electrically recording information such as a ROM and a flash memory, or the like.

When the recording medium 48 having the scheduler 10 recorded on it is installed in the drive unit 43, the scheduler 10 is installed in the auxiliary storage unit 44 via the drive device 43 from the recording medium 48. The scheduler 10 downloaded from the network 34 is installed on the auxiliary storage unit 44 via the interface unit 47. The auxiliary storage device 44 stores various files or data and so on in addition to the scheduler 10.

The main storage unit 45 reads the scheduler 10 from the auxiliary storage unit 44 at a time of activating the scheduler 10 and stores the scheduler 10 in the main storage unit 45. The arithmetic processing unit 46 realizes various processing described below in accordance with the scheduler 10 stored in the main storage unit 45.

When the recording medium 48 having the SP 11 to the SP 14 recorded on it is installed in the drive unit 43, the SP 11 to the SP 14 are installed in the auxiliary storage unit 44 via the drive unit 43 from the recording medium 48. The SP 11 to the SP 14 downloaded from the network 34 are installed in the auxiliary storage unit 44 via the interface unit 47. The auxiliary storage device 44 stores various files or data and so on in addition to the SP 11 to the SP 14.

The main storage unit 45 reads the SP 11 to the SP 14 from the auxiliary storage unit 44 at a time of activating the SP 11 to the SP 14 and stores the SP 11 to the SP 14 in the main storage unit 45. The arithmetic processing unit 46 realizes various processing described below in accordance with the SP 11 to the SP 14 stored in the main storage unit 45.

### (Processing Sequence)

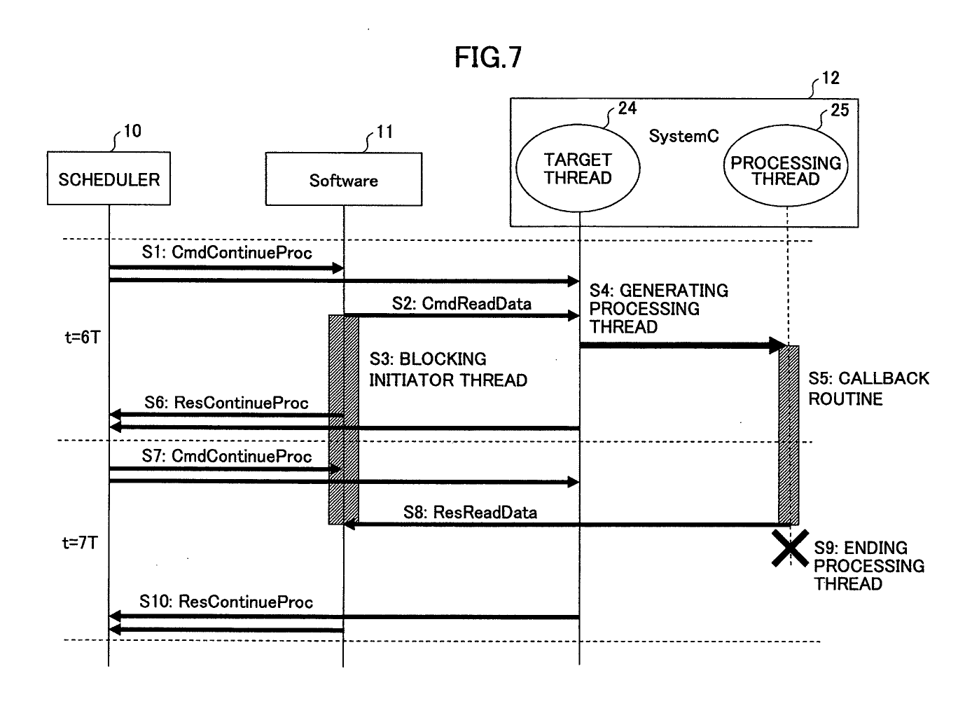

FIG. 7 is an example time chart illustrating an action of the target thread of Embodiment 1. FIG. 7 illustrates an example of the SP 11 and the SP 12. In step S1, the scheduler 10 sends a CmdContinueProc command to the SP 11 and the SP 12. The SP 11 and the SP 12 simulate during the Quantum period in a case where the CmdContinueProc command is received.

In step S2, the SP 11 being an initiator thread issues a CmdReadData command to the SP 12 being a target process. After issuing the CmdReadData command, the SP 11 proceeds to step S3 and is blocked. The terminology “blocked” means that processing is not carried out until the CmdReadData command ends.

In step S4, a target thread 24 of the SP 12 generates a processing thread 25 for the callback routine. Thus, the processing thread takes over the transaction processing. In step S5, the processing thread 25 carries out a callback routine for the CmdReadData command.

If the simulation time is the end of the Quantum period, the SP 11 as the initiator process and the target thread 24 of the SP 12 as the target process report ResContinueProc to the scheduler 10. In step S7, the scheduler 10 gives a CmdContinueProc command of the Quantum period to all SP (SP 11 and SP 12 in the example of FIG. 7).

In step S8, after the callback routine ends, the processing thread 25 returns a response packet (ResReadData) as a response to the CmdReadData command to the SP 11 of the initiator process. In step S9, the processing thread 25 is ended by itself.

If the simulation time is the end of the Quantum period, the SP 11 as the initiator process and the target thread 24 of the SP 12 as the target process report ResContinueProc to the scheduler 10.

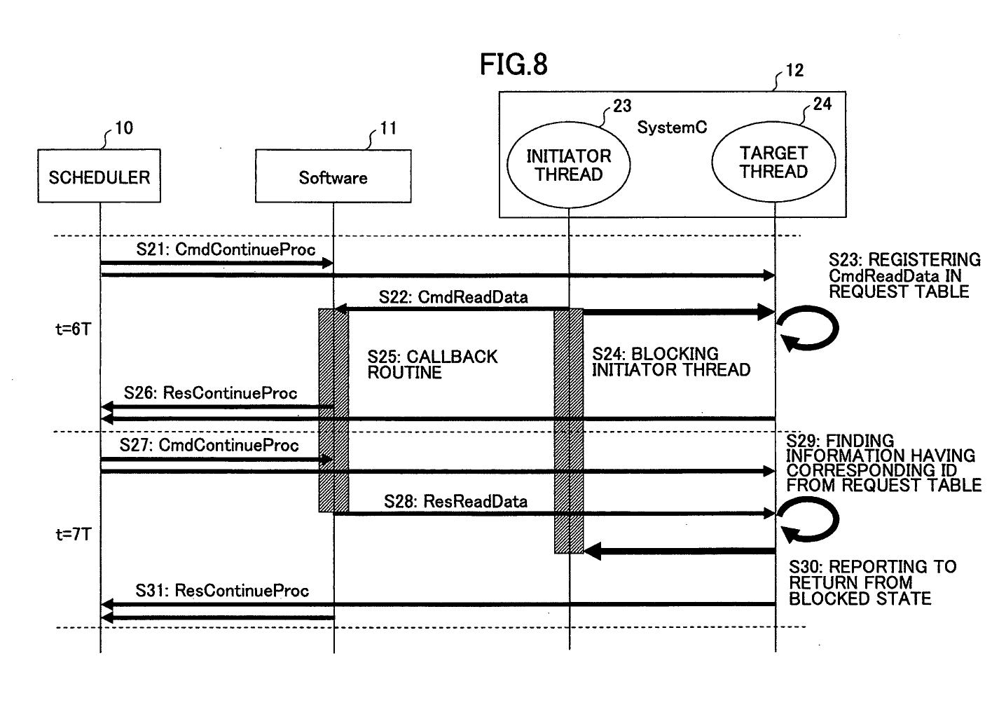

FIG. 8 is an example time chart illustrating an action of an initiator thread of the Embodiment. FIG. 8 illustrates another example of the SP 11 and the SP 12. In step S21, the scheduler 10 sends a CmdContinueProc command to the SP 11 and the SP 12. The SP 11 and the SP 12 simulate during the Quantum period in a case where the CmdContinueProc command is received.

In step S22, an initiator thread 23 of the SP 12 issues a CmdReadData command to which an ID is added to the SP 11. Further, the initiator thread 23 of the SP 12 associates information of the command packet of the issued CmdReadData command with the ID added to the CmdReadData command, and reports the associated information and the ID to the target thread 24. In step S23, the target thread 24 registers the associated information of the CmdReadData command and ID added to the CmdReadData command in a request table. After issuing the CmdReadData command to the SP 11, the initiator thread 23 of the SP 12 is blocked in step S24.

In step S25, the SP 11 as the target process receives the CmdReadData command, calls a callback routine and carries out the callback routine. If the simulation time is the end of the Quantum period, the SP 11 as the target process and the target thread 24 of the SP 12 as the initiator process reports ResContinueProc to the scheduler 10. In step S27, the scheduler 10 gives a CmdContinueProc command of the Quantum period to all SP (SP 11 and SP 12 in the example of FIG. 8).

In step S28, after the callback routine ends, the SP11 as the target process returns a response packet (ResReadData) to the target thread 24 as the initiator process. The target thread 24 finds information having corresponding ID from information of command packets registered in the request table based on the ID described in the response packet.

In step S30, the target thread 24 of the SP 12 reports that the CmdReadData command is ended and a return from the blocked state to the initiator thread 23. Upon the report from the target thread 24, the initiator thread 23 returns from the blocked state to the original state.

If the simulation time is the end of the Quantum period, the SP 11 as the target process and the target thread 24 of the SP 12 as the initiator process report ResContinueProc to the scheduler 10 in step S31.

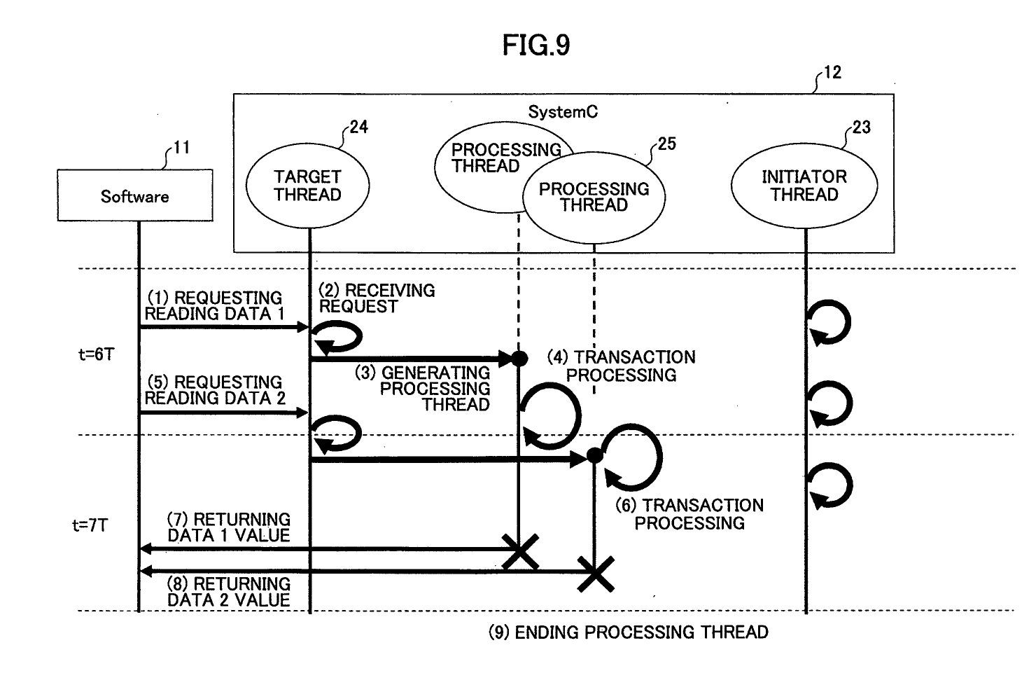

FIG. 9 is an example time chart for explaining an effect of the Embodiment. The SP 12 of the Embodiment separately provides the target thread 24 and the processing thread 25 for the operation. Therefore, even if the transaction processing spends a substantial amount of time, the target thread 24 can constantly receive the CmdWriteData command as the data writing request command from another SP (the SP 11 in FIG. 9) or the CmdReadData command as the data reading request command from another SP (the SP 11 in FIG. 9).

In the example of FIG. 9, it is possible to receive “requesting to read data 2” with the target thread 24 during a transaction processing of “requesting to read data 1”. A transaction request such as the CmdWriteData or CmdReadData command issued by the SP 11 is not suspended by the SP 12. A transaction response can be certainly received by the SP 11 because the transaction response is processed by the processing thread 25. Therefore, with a distributed simulation, a risk of causing deadlock is drastically reduced.

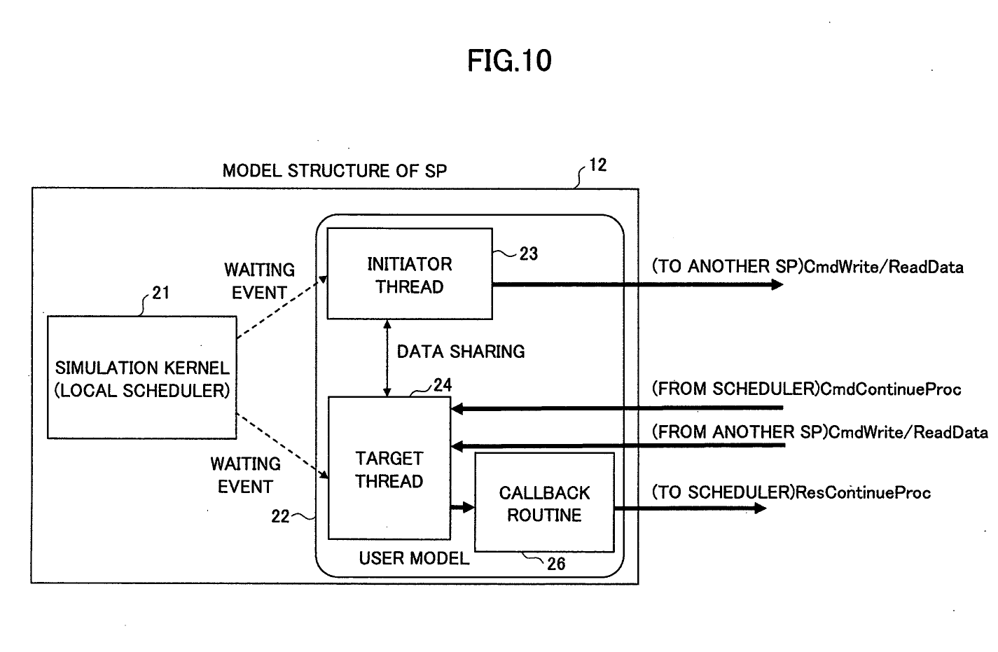

FIG. 10 is a schematic view for explaining an effect of the embodiment. The specific processing with the SP 12 illustrated in FIG. 10 can be encapsulated in a callback routine 26 for the transaction processing.

Since it is possible to encapsulate the processing peculiar to the SP 12 into the callback routine 26, the SP 12 of FIG. 10 can avoid the deadlock caused by the communication between the SPs by making the target thread 24 dedicate to receipt of the communication between the SPs and the management of the Quantum period without changing the description of the target thread 24.

### Embodiment 1

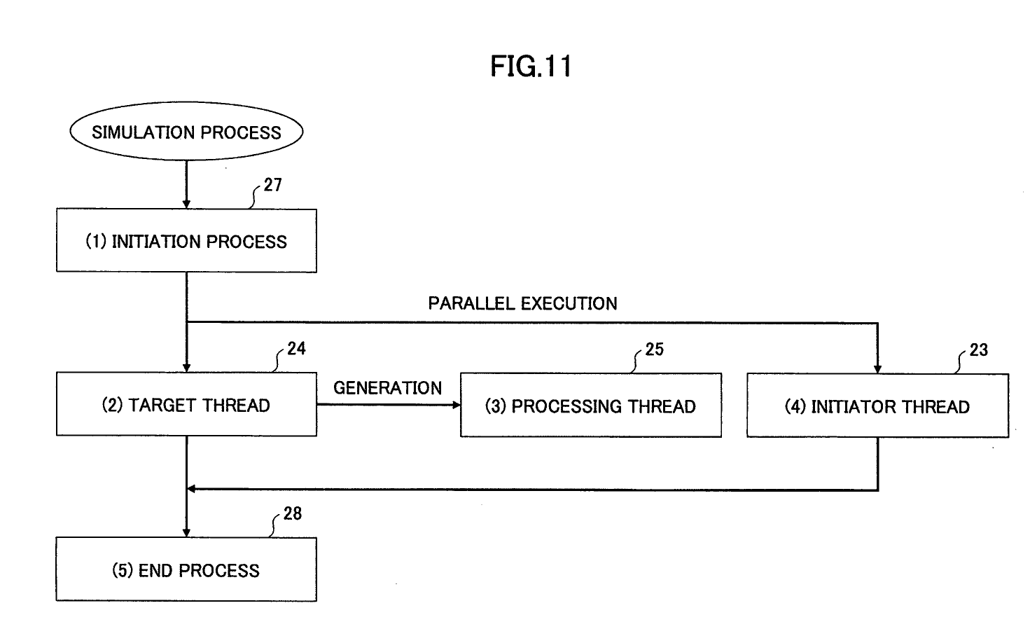

The simulation process includes five parts of an initiation process 27, a target thread 24, a processing thread 25, an initiator thread 23 and an end process 28. FIG. 11 illustrates an example structure of a simulation process. The target thread 24, the processing thread 25 and the initiator thread 23 illustrated in FIG. 11 are carried out in parallel in the simulation process.

The initiation process 27 is provided to connect a proxy server described later. The target thread 24 functions as a target device and handles all packets to be received. The processing thread 25 is generated by the target thread 24 as a thread of carrying out a callback routine 26.

The initiator thread 23 functions as the initiator device and sends a command packet such as a CmdWriteData command and a CmdReadData command. The end process 28 ends a connection with the proxy server described below.

An example data structure of C level is described in Embodiment 1. With Embodiment 1, a packet, a socket and a port are used.

The actual packet has a structure peculiar to a packet type such as Packet_CmdXXX and Packet_ResYYY. However, all packets have a packet header in which a data element is similarly set. Therefore, pointers of all packets can be referred by using the packet header.

Each simulation process has only one socket. All incoming packets reach the sockets. Sockets are used for all outgoing packets directed to the scheduler 10. The socket has one or more ports. A command packet such as a CmdWriteData command and a CmdReadData command is sent from a port.

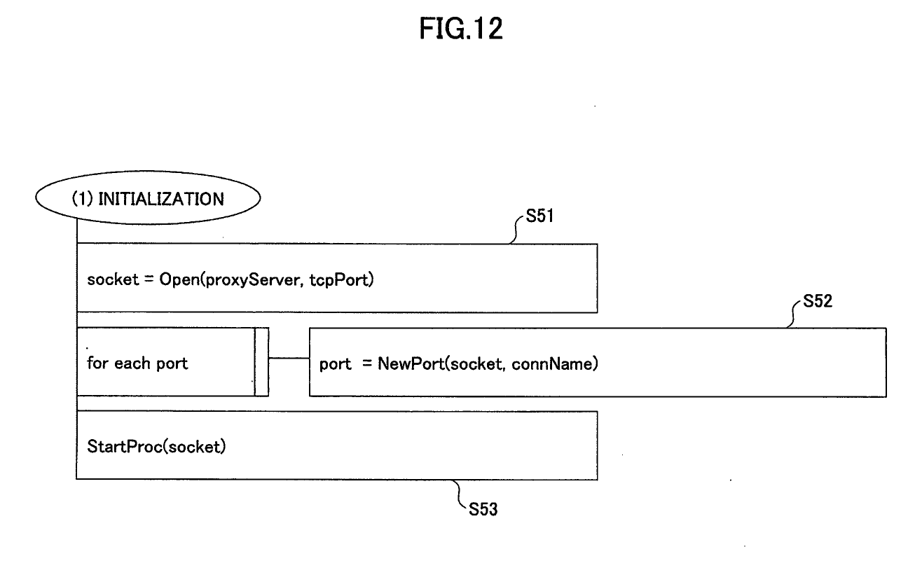

FIG. 12 is an example flowchart of an initiation process. In step S51, the initiation process 27 opens a connection with the scheduler 10. Specifically, the initiation process 27 generates the socket using an Open function. An argument of the Open function may be proxyServer and tcpPort. For example, the initiation process 27 designates a scheduler 10 as proxyServer and designates a TCP port of the scheduler as tcpPort to thereby open a connection with the scheduler 10.

In step S52, the initiation process 27 generates a port for reading or writing data. Specifically, the initiation process 27 generates the port for reading or writing data using a NewPort function. An argument of the NewPort function may be socket and ConnName. For example, the initiation process 27 designates a socket generated in step S51 as socket and designates a connection name as ConnName to thereby generate the port.

Connection names designated by ConnName are given to the respective ports. The connection name designated by ConnName becomes the name of the corresponding port in order to globally associate the connection name with one of the all simulation processes. The scheduler 10 connects the port having the connection name.

In step S53, the initiation process 27 makes the simulation process prepare start of processing the simulation process. Specifically, the initiation process 27 makes the simulation process prepare for the start of processing the simulation process using a StartProc function. An argument of the StartProc function is socket. For example, if the initiation process 27 designates a socket generated in step S51 as socket, the simulation process can prepare for the start of processing the simulation process. Information of the port for the simulation process is reported to the scheduler 10. Thereafter, the simulation process receives a CmdContinueProc command from the scheduler 10. Then, ResStartProc is returned and the processing can be started.

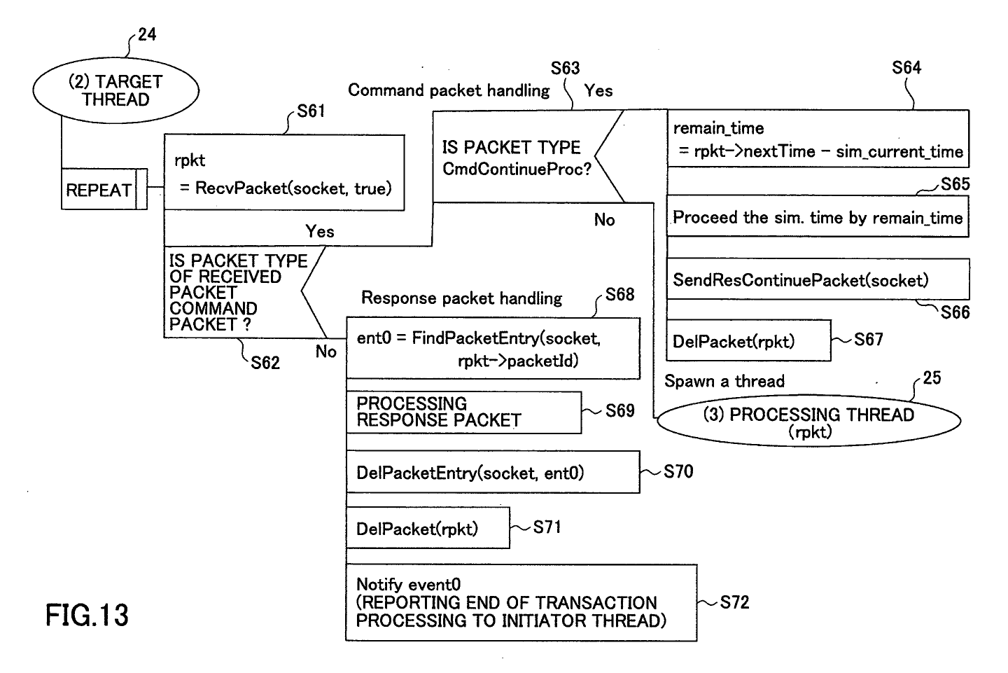

FIG. 13 is an example flowchart of a target thread process. The processing illustrated in FIG. 13 is repeatedly carried out after the initialization with the initiation process 27.

Then, in step S61, the target thread 24 waits for a receipt of packet using blocking. Specifically, the target thread 24 waits for receipt of a packet from socket using blocking caused by a RecvPacket function. An argument of the RecvPacket function may be socket and a boolean variable of blocking.

For example, the target thread 24 designates the socket generated in step S51 as socket and designates true as the boolean variable of blocking. Then, it is possible to wait using blocking until a packet reaches the designated socket.

In step S62, the target thread 24 determines whether the packet type reaching the designated socket is a command packet. If the packet type is determined to be the command packet, the target thread 24 proceeds to step S63, receives the command packet arriving the designated socket and determines whether the packet type of the command packet is a CmdContinueProc command.

If the packet type of the command packet is determined to be a CmdContinueProc command, the target thread 24 proceeds to step S64 and remain_time is acquired. It is possible to calculate remain_time by subtracting a present simulation time from a starting time of the Quantum period next to a Quantum period while the CmdContinueProc command is received.

In step S65, the target thread 24 extends the start of the simulation time by a remain_time calculated in step S64 and thereafter starts to count the simulation time. In step S66, the target thread 24 reports ResContinueProc to the scheduler 10. Specifically, the target thread 24 reports ResContinueProc to the scheduler 10 using a Send_ResContinueProc function. A socket is designated as an argument of the Send_ResContinueProc function. For example, the target thread 24 can report ResContinueProc to the scheduler 10 by designating the socket generated in step S51.

In step S67, the target thread 24 deletes the packet reaching the designated socket. Specifically, the target thread 24 deletes the packet reaching the designated socket using a DelPacket function. An argument of the DelPacket function may be Packet. For example, the target thread 24 designates a packet (rpkt) reaching the designated socket. Then, the target thread 24 deletes the packet reaching the designated socket and releases a memory allocated to the packet.

In step S63, if it is determined that the packet type of the command packet is determined not to be the CmdContinueProc command, the target thread 24 generates the processing thread 25 for the packet (rpkt) reaching the designated socket.

In step S62, if the packet type is determined not to be the command packet, the target thread 24 proceeds to step S68 and receives a response packet reaching the designated packet and checks whether the response packet matches the command packet sent by the initiator thread 23.

Specifically, it is checked by the target thread 24 whether the response packet matches the command packet sent by the initiator thread 23 using a FindPacketEntry function. An argument of the FindPacketEntry function may be socket and packetId.

For example, the target thread 24 designates the socket generated in step S51 and designates the ID as packetId described in the response packet. With this it is possible to find registration of the command packet matching the response packet from a request table.

In step S69, the target thread 24 carries out processing for the response packet. In step S70, the target thread 24 deletes registration of information of the command packet matching the response packet from the request table. Specifically, the target thread 24 uses a DelPacketEntry function to thereby deletes registration of information of the command packet matching the response packet from the request table.

An argument of the DelPacketEntry function may be socket and ent0. For example, the target thread 24 designates the socket generated in step S51 as socket and designates the registration found in step S68 as ent0. It is possible to delete registration of the information of the command packet matching the response packet from the request table.

In step S71, the target thread 24 deletes the packet reaching the designated socket in a similar manner to step S67. In step S72, the target thread 24 reports the end of the transaction processing to the initiator thread 23.

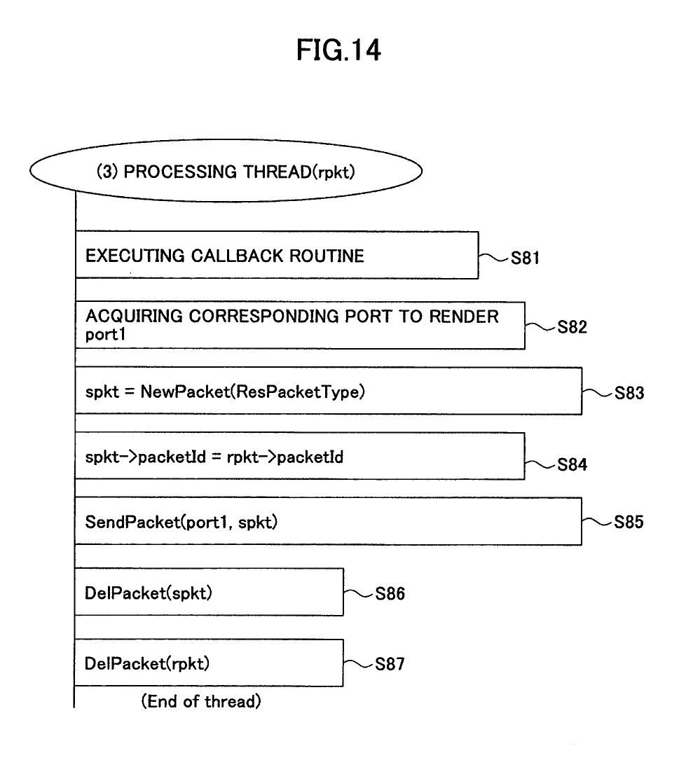

FIG. 14 is an example flowchart of processing with a processing thread. In step S81, the processing thread 25 carries out a callback routine with a processing command of the callback routine of the blocked transaction. The target thread 24 passes the packet (rpkt) received by the target thread 24 to the processing thread 25.

In step S82, the processing thread 25 acquires a port corresponding to the packet (rpkt) and the port is called port1. In step S83, the processing thread 25 generates a new packet (spkt) of a response packet type. Specifically, the processing thread 25 generates the new packet (spkt) of the response packet type using a NewPacket function. An argument of the NewPacket function may be PacketType. For example, the processing thread 25 generates the new packet (spkt) of the response packet type by designating ResPacketType as ResPacket.

In step S84, the processing thread 25 renders packetId described in the new packet (spkt) to be packetId copied from the packet (rpkt). The processing thread 25 renders the packet (rpkt) and packetId described in the packet (rpkt) to be the same.

In step S85, the processing thread 25 sends the new packet (spkt) from port1. Specifically, the processing thread 25 can send the new packet (spkt) from port1 by using a SendPacket function. An argument of the SendPacket function may be port and packet. When the processing thread 25 designates port1 as port and designates the new packet (spkt) as packet, the new packet (spkt) can be sent from port1.

In step S86, the target thread 24 deletes the new packet in a similar manner to step S67. In step S87, the target thread 24 deletes the packet (rpkt) received by the target thread 24 in a similar manner to step S67.

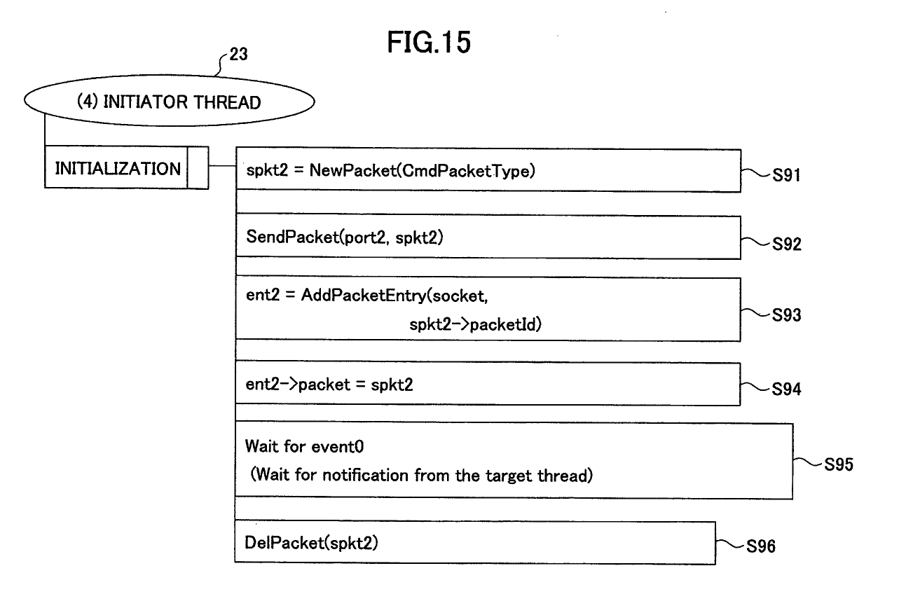

FIG. 15 is an example flowchart of processing of an initiator thread. The initiator thread 23 sends information of command packets of a CmdWriteData command or a CmdReadData command if the simulation process reads or writes data for another simulation process.

After initialization with the initiation process 27, the initiator thread 23 proceeds to step S91 and generates the new packet (spkt2) of the command packet type. Specifically, the initiator thread 23 generates the new packet (spkt2) of the command packet type using the NewPacket function. An argument of the NewPacket function may be PacketType. For example, the initiator thread 23 can generate the new packet (spkt2) of the command packet type by designating CmdPacketType as PacketType.

In step S92, the initiator thread 23 sends the new packet (spkt2) from port2. Specifically, the initiator thread 23 can send the new packet (spkt2) from port2 in a similar manner to step S85 by using the SendPacket function.

In step S93, the initiator thread 23 registers the new packet (spkt2) after sending the new packet (spkt2) from port2. Therefore, the target thread 24 can wait a response packet to match. Specifically, the initiator thread 23 registers the new packet (spkt2) in the packet entry table using an AddPacketEntry function. An argument of the AddPacketEntry function may be socket and PacketId.

For example, the initiator thread 23 designates the socket generated in step S51 as socket and designates PacketId of the new packet (spkt2) as PacketId to thereby enable registering the new packet (spkt2) in the packet entry table.

In step S94, the initiator thread 23 renders the packet registered in ent2 of the packet entry table to be spkt2. In step S95, the initiator thread 23 waits until an event occurs. In step S96, the initiator thread 23 deletes the new packet (spkt2) in a similar manner to step S86.

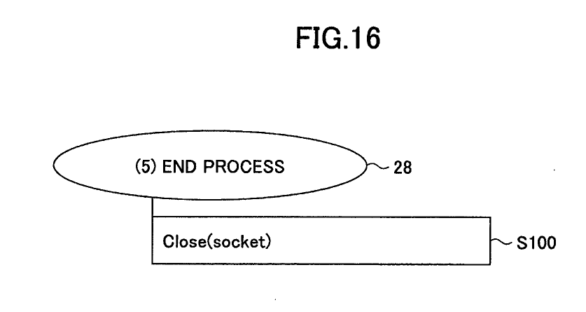

FIG. 16 is an example flowchart of processing with an end process. In step S100, the end process 28 closes a connection with a proxy server and releases an allocating resource. Specifically, the end process 28 closes the connection or releases resource using a Close function. An argument of the Close function is socket. For example, when the end process 28 designates the socket generated in step S51 as socket, the end processing thread 28 can close sockets opening for the proxy server and all the ports.

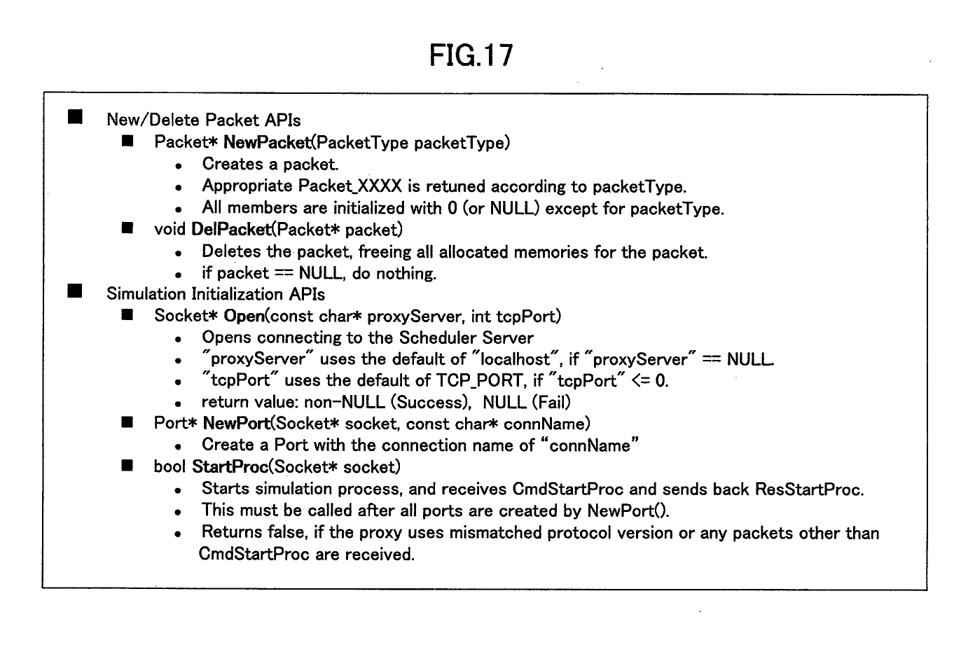

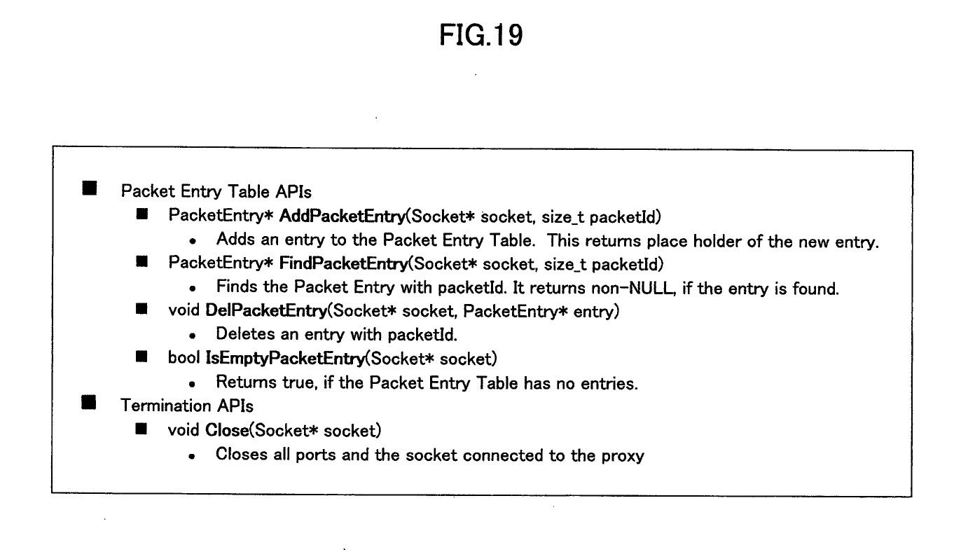

Various functions are used in processing illustrated in FIG. 12 to FIG. 16. For example, the functions may be served by an Application Program Interface (API). Example C level functions are illustrated in FIG. 17 7o FIG. 19. FIG. 17 and FIG. 19 illustrate a structure of the example C level functions.

The simulation program of the Embodiment may be served as package software or by a WEB service.

A process as an executable unit recited in claims may be a thread, a task or the like.

With Embodiment 1, there may be provided a non-transitory recording medium saving a simulation program representing a sequence of instructions and carrying out a distributed processing of a simulation by communicating with a scheduler and another simulation program, the simulation program executable by a computer to perform: resuming, when a continuation instruction is received from the scheduler, the distributed processing; suspending, when a predetermined time passes after the resuming, the distributed processing; reporting the suspending to the scheduler; adding an identifier to a read or write request of data and sending the a read or write request of data having the identifier to the other simulation program; reporting a correspondence relationship between the read or write request and the identifier to a process as an executable unit which receives a response to the read or write request from the other simulation program; and causing the process as an executable unit to report an end of a processing for the read or write request based on the response to the read or write request from the other simulation program and the correspondence relationship.

With the Embodiment, the deadlock caused between the simulation programs may be avoidable.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable, non-transitory medium storing a simulation program that causes a computer to execute a distributed processing by cooperating with a scheduler and another simulation program, the distributed processing comprising:
resuming, when a continuation instruction is received from the scheduler, the distributed processing;
suspending, when a predetermined time passes after the resuming, the distributed processing;
reporting the suspending to the scheduler;
generating, when a read or write request of data is received from the other simulation program, a process for processing the read or write request of the data; and
processing the read or write request of the data by the process.

2. The computer-readable, non-transitory medium according to claim 1,
wherein when the process ends reading or writing the data the process sends an end report to the other simulation program.

3. A simulation apparatus carrying out a distributed processing of a simulation by communicating with a scheduler and another simulation program, the simulation apparatus comprising:
a resuming unit for resuming the distributed processing when a continuation instruction is received from the scheduler, suspending the distributed processing when a predetermined time passes after the resuming, and reporting the suspending to the scheduler;
a generation unit for generating a process for processing the read or write request of the data when a read or write request of data is received from the other simulation program; and
a causing unit for causing the process to read or write the data.

4. The simulation apparatus according to claim 3,
wherein when the process ends reading or writing the data the process sends an end report to the other simulation program.

5. A simulation apparatus carrying out a distributed processing of a simulation by communicating with a scheduler and another simulation program, the simulation apparatus comprising:
a processor configured to execute a procedure, the procedure comprising:
resuming, when a continuation instruction is received from the scheduler, the distributed processing;
suspending, when a predetermined time passes after the resuming, the distributed processing;
reporting the suspending to the scheduler;
generating, when a read or write request of data is received from the other simulation program, a process for processing the read or write request of the data; and
processing the read or write request of the data by the process.

6. A simulation method of carrying out a distributed processing of a simulation by communicating with a scheduler and another simulation program, the simulation method comprising:
resuming, when a continuation instruction is received from the scheduler, the distributed processing;
suspending, when a predetermined time passes after the resuming, the distributed processing;
reporting the suspending to the scheduler;
generating, when a read or write request of data is received from the other simulation program, a process for processing the read or write request of the data; and
processing the read or write request of the data by the process.

7. The simulation method according to claim 6,
wherein when the process ends reading or writing the data the process sends an end report to the other simulation program.
